(19) United States
(12) Patent Application Publication
(10) Pub. No.: US 2013/0271030 A1
(43) Pub. Date: Oct. 17, 2013

(54) Road Lamp System

(71) Applicant: TOSHIBA LIGHTING TECHNOLOGY CORPORATION, Yokosuka-shi (JP)

(72) Inventors: Hidenori Nishigaki, Yokosuka-shi (JP); Kenji Takahashi, Yokosuka-shi (JP); Hitoshi Kawano, Yokosuka-shi (JP); Shinichi Kumashiro, Yokosuka-shi (JP)

(73) Assignee: TOSHIBA LIGHTING & TECHNOLOGY CORPORATION, Yokosuka-shi (JP)

(21) Appl. No.: 13/796,244

(22) Filed: Mar. 12, 2013

(30) Foreign Application Priority Data
Apr. 13, 2012 (JP) 2012-092408

(51) Int. Cl. H05B 37/02

(52) U.S. Cl. CPC H05B 37/02
USPC 315/297; 315/307

(57) ABSTRACT

According to one embodiment, a road lamp system includes a light-emitting section configured to irradiate light and an image pickup section. A power supply section operates as a driving power supply for the light-emitting section and performs power line communication with an external management apparatus. A road-lamp control section receives a control signal from the management apparatus via the power supply section and controls the light-emitting section on the basis of the control signal. A camera control section receives the control signal and determines, on the basis of image information transmitted from the image pickup section, whether a control operation instructed by the received control signal is executed.

### CROSS-REFERENCE TO RELATED APPLICATION

This application is based upon and claims the benefit of priority from Japanese Patent Application Laid-Open No. 2012-092408 filed on Apr. 13, 2012, the entire contents of which are incorporated herein by reference.

### FIELD

Embodiments described herein relate generally to a road lamp system.

### BACKGROUND

In a road lamp in the past, in general, to detect non-lighting, an operator actually goes to the vicinity of the road lamp and determines whether the road lamp is lit, for example, the operator checks non-lighting of a lamp by visually observing a place where a plurality of road lamps are set. To simplify non-lighting detection work by the operator, in recent years, there is proposed a road lamp system in which information concerning an image picked up by an existing camera for traffic monitoring is transferred to a management center and the management center performs non-lighting detection.

However, in the road lamp system in the past, it may be very difficult to autonomously perform the non-lighting detection on a road lamp side in synchronization with control signals for ON and OFF control, dimming control, and the like. Therefore, in the road lamp system in the past, a computer on the management center side needs to perform image processing and non-lighting position detection processing using image information for traffic monitoring while performing original processing for traffic monitoring. Therefore, a processing load on the management center side increases.

### DESCRIPTION OF THE DRAWINGS

FIG. 1 is a diagram showing an example of an overall configuration of a road lamp control system;

FIG. 2 is a diagram showing an example of the configuration of a road lamp system according to a first embodiment;

FIG. 3 is a flowchart for explaining the operation of a camera control section;

FIG. 4 is a diagram showing an example of the configuration of a road lamp system according to a second embodiment;

FIG. 5 is a diagram showing an overview of information concerning a road lamp lighting time period and electricity charges;

FIG. 6 is a flowchart for explaining the operation of a power-supply control section; and

FIG. 7 is a flowchart for explaining the operation of a camera control section.

### DETAILED DESCRIPTION

It is an object of embodiments to provide a road lamp system capable of realizing simplification of work by an operator and reducing a processing load on a management apparatus side that controls road lamps.

In general, according to one embodiment, a road lamp system 1A includes a light-emitting section 23 configured to irradiate light and an image pickup section 31. A power supply section 21 operates as a driving power supply for the light-emitting section 23 and performs power line communication with an external management apparatus 2. A road-lamp control section 22 receives a control signal from the management apparatus 2 via the power supply section 21 and controls the light-emitting section 23 on the basis of the control signal. A camera control section 32 receives the control signal and determines, on the basis of image information transmitted from the image pickup section 31 functioning as a monitoring camera section, whether a control operation instructed by the received control signal is executed.

In the embodiment, the camera control section 32 determines, concerning respective light-emitting sections of a plurality of road lamp units including the own system, whether the control operation instructed by the control signal is executed.

In the embodiment, the control signal may be a control signal for controlling ON or OFF of the light-emitting section 23. The camera control section 32 determines whether the light-emitting section 23 is turned on or off.

In the embodiment, the control signal may be a control signal for dimming control for the light-emitting section 23. The camera control section 32 determines whether the light-emitting section 23 is dimmed as instructed.

In the embodiment, if the camera control section 32 determines that the control operation instructed by the control signal is not executed, the camera control section 32 transmits a notification signal including a result of the determination to the management apparatus 2 via the power supply section 21.

In the embodiment, a road lamp system 1B includes a power storing section 42 configured to store electric power obtained by solar power generation and a power-supply control section 43 configured to determine whether a driving power supply for a light-emitting section 23B is the power supply section 21 or the power storing section 42. A road-lamp control section 22B performs, according to a result of the determination by the power-supply control section 43, control for switching the driving power supply for the light-emitting section 23B.

In the embodiment, the power-supply control section 43 determines, on the basis of information concerning a road lamp lighting time period and information concerning electricity charges set for each of time periods, whether the driving power supply is the power supply section 21 or the power storing section 42.

In the embodiment, the electric power stored in the power storing section 42 can be used for purposes other than road lamp lighting.

In the embodiment, the camera control section 32 controls, on the basis of information concerning a road lamp lighting time period, information concerning electricity charges set for each of time periods, and image information, the intensity of the light irradiated by the light-emitting section 23.

The road lamp system according to the embodiment is explained with reference to the drawings. Components having the same functions in the embodiment are denoted by the same reference numerals and signs and redundant explanation of the components is omitted.

### First Embodiment

### Configuration Example of a Road Lamp Control System

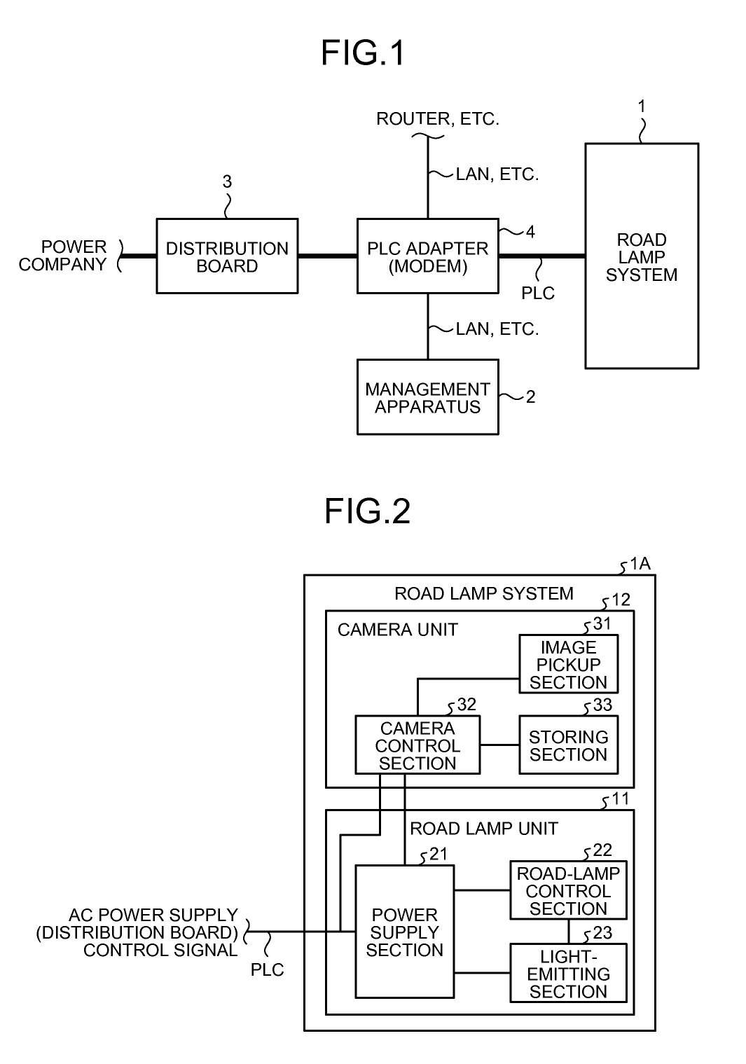

FIG. 1 is a diagram showing an example of an overall configuration of a road lamp control system including a road lamp system 1. In FIG. 1, in the road lamp control system, the road lamp system 1 and the management apparatus 2 perform power line communication (PLC) via a PLC (Power Line Communication) adapter (a PLC modem) 4 to thereby perform control such as ON and OFF control and dimming control for road lamps. The PLC modem 4 may be connected to the management apparatus 2 by wire such as a LAN or by radio or may be provided integrally with the management apparatus 2. Peripheral apparatuses such as a router and a printer may be connected to the PLC modem 4 by wire such as a LAN or by radio. Electric power may be supplied to the PLC modem 4 via a distribution board 3. In the PLC, electric appliances to which electric power is supplied by sockets such as home electric appliances can be connected. Communication can be performed among the appliances.

### Configuration Example of the Road Lamp System

FIG. 2 is a diagram showing an example of the configuration of a road lamp system according to a first embodiment. In FIG. 2, as an example of the road lamp system 1 shown in FIG. 1, a road lamp system 1A including a road lamp unit 11 and a camera unit 12 is shown. The road lamp unit 11 includes the power supply section 21, the road-lamp control section 22, and the light-emitting section 23. The camera unit 12 includes the image pickup section 31, the camera control section 32, and a storing section 33.

In FIG. 2, the power supply section 21 supplies electric power to the light-emitting section 23 and notifies the road-lamp control section 22 of a control signal received from the management apparatus 2 through the PLC. In this embodiment, as an example of the control signal, a control signal for controlling ON and OFF of road lamps and a control signal for dimming control are assumed. The road-lamp control section 22 controls the light-emitting section 23 on the basis of the control signal notified from the power supply section 21. The light-emitting section 23 is driven by the power supply section 21 to perform ON and OFF processing and dimming processing according to the control by the road-lamp control section 22.

In FIG. 2, the image pickup section 31 is a camera main body including an image pickup element. The image pickup section 31 transmits information concerning a picked-up image (image information) to the camera control section 32. The camera control section 32 transmits the image information obtained from the image pickup section 31 to the management apparatus 2 through the PLC. The camera control section 32 is configured to be capable of receiving the control signal through the PLC (via the power line). Electric power is supplied to the camera control section 32 from the power supply section 21 or the power line. If the camera control section 32 receives the control signal via the power line, the camera control section 32 starts monitoring of the image information obtained from the image pickup section 31. The camera control section 32 determines whether a plurality of monitoring target road lamp units (including the own road lamp unit) are executing processing instructed by the control signal. In the storing section 33, posture control information indicating camera positions (directions) where the plurality of monitoring target road lamp units can be monitored is stored. Further, identifiers (address information) for identifying the plurality of monitoring target road lamp units and region information for specifying image positions of light sources of the road lamp units are stored in an associated state.

### Operation of the Road Lamp System

A characteristic operation of the road lamp system 1A according to this embodiment is explained. In this embodiment, it is assumed that posture control information indicating camera positions (directions) in monitoring a plurality of monitoring target road lamp units is registered in advance in the storing section 33 of the road lamp system 1A by the management apparatus 2. Further, it is assumed that identifiers for identifying the plurality of monitoring target road lamp units and region information for specifying image positions of light sources of the road lamp units are registered in advance in the storing section 33 of the road lamp system 1A by the management apparatus 2. These kinds of information (the posture control information, the identifiers, and the region information) can be updated as appropriate by an operator (a user) of the management apparatus 2 according to an increase and a decrease of the monitoring target road lamp units.

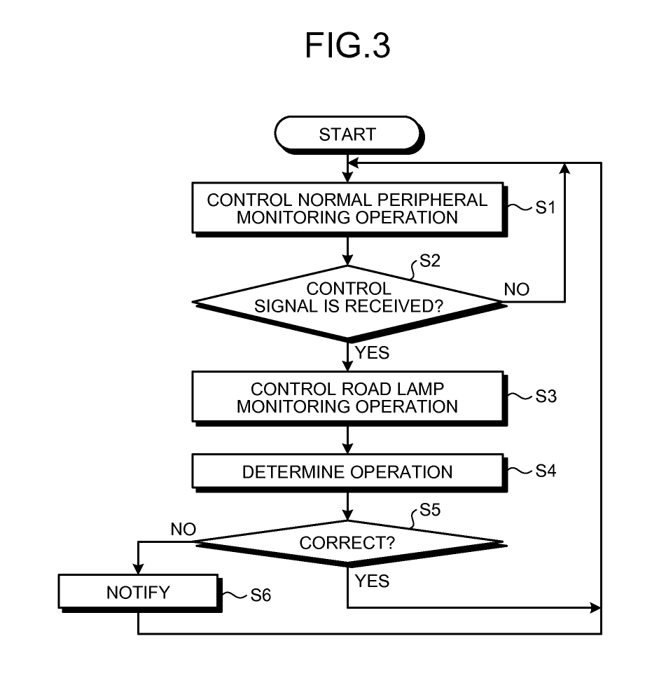

FIG. 3 is a flowchart for explaining the operation of the camera control section 32. As an example, it is assumed that the road lamp unit 11 and a plurality of road lamp units arranged in the vicinity of the road lamp unit 11 are monitoring targets and the management apparatus 2 transmits a control signal for turning on light-emitting sections of the respective monitoring target road lamp units to the power supply section 21 of the road lamp unit 11. The plurality of road lamp units arranged in the vicinity of the road lamp unit 11 have a function equivalent to the function of the road lamp unit 11 except that the plurality of road lamp units are not connected to the camera unit 12 (a monitoring camera). The vicinity indicates a range that can be monitored by the camera unit 12.

First, the camera control section 32 controls a normal peripheral monitoring operation by the image pickup section 31 (Act 1). For example, the image pickup section 31 sets the vicinity as an image pickup target according to the control by the camera control section 32 and transmits obtained image information to the camera control section 32. The camera control section 32 transmits the image information received from the image pickup section 31 to the management apparatus 2 through the power supply section 21 or directly via the power line. The camera control section 32 waits for a control signal transmitted from the management apparatus 2 while transmitting the image information obtained from the image pickup section 31 to the management apparatus 2 (No in Act 2).

Thereafter, if the camera control section 32 receives, for example, a control signal for turning on the light-emitting sections of the respective monitoring target road lamp units from the management apparatus 2 during the image pick up section 31 executes the normal peripheral monitoring operation (Yes in Act 2), the camera control section 32 performs control for switching the operation of the image pickup section 31 from the normal peripheral monitoring operation to an operation for monitoring road lamps (a road lamp monitoring operation) (Act 3). In performing the control, the camera control section 32 reads out posture control information in monitoring monitoring target road lamp units from the storing section 33 and controls the posture of the camera unit 12 on the basis of the posture control information. The image pickup section 31 sets the monitoring target road lamp units as image pickup targets according to the control by the camera control section 32 and transmits obtained image information to the camera control section 32.

Subsequently, the camera control section 32 that receives the image information from the image pickup section 31 according to the road lamp monitoring operation determines whether the monitoring target road lamp units are performing a correct operation conforming to the control signal (Act 4). For example, the camera control section 32 extracts identifiers of the respective monitoring target road lamp units from the received control signal and reads out the region information (region information for specifying image positions of light sources) associated with the identifiers. The camera control section 32 checks brightness information in pixels of regions on the basis of the received image information to thereby determine whether the light-emitting sections of the monitoring target road lamp units are irradiating light (are in the ON state). As an example, a threshold for determining the ON state is provided. If the brightness of the regions exceeds the threshold, the camera control section 32 determines that the light-emitting sections are in the ON state. If the brightness of the regions is equal to or smaller than the threshold, the camera control section 32 determines that the light-emitting sections are in the OFF state.

For example, if determining that all the light-emitting sections of the monitoring target road lamp units are in the ON state (Yes in Act 5), the camera control section 32 performs control for switching the operation of the image pickup section 31 from the road lamp monitoring operation to the normal peripheral monitoring operation (Act 1).

On the other hand, if determining that at least any one of the light-emitting sections of the monitoring target road lamp units is in the OFF state (No in Act 5), the camera control section 32 transmits a non-lighting detection signal including an identifier of the road lamp unit in the OFF state to the management apparatus 2 (Act 6). Thereafter, the camera control section 32 performs control for switching the operation of the image pickup section 31 from the road lamp monitoring operation to the normal peripheral monitoring operation (Act 1).

### Effects of the First Embodiment

As explained above, in this embodiment, the camera unit 12 autonomously determines whether the operation indicated by the control signal is correctly executed. Consequently, the user does not need to actually go to the vicinity of the road lamps. The management apparatus 2 that controls the road lamp system does not need to perform image processing for non-lighting detection. Therefore, it is possible to perform non-lighting detection for the road lamp units and to realize a reduction in a processing load.

In this embodiment, the management apparatus 2 transmits the control signal for turning on the light-emitting sections of the respective monitoring target road lamp units to the power supply section 21 of the road lamp unit 11. However, the present embodiment is not limited to this. That is, the operation of the flowchart of FIG. 3 can be applied in other control information.

For example, if the management apparatus 2 transmits a control signal for turning on any one of the light-emitting section of any one of the monitoring target road lamp units, the camera control section 32 performs the operation determination in Act 4 concerning the one road lamp unit designated by the control signal. Consequently, it is possible to detect non-lighting of a specific road lamp unit.

If the management apparatus 2 transmits a control signal for turning off the light-emitting sections of a part or all of the monitoring target road lamp units, the camera control section 32 performs the operation determination in Act 4 concerning the road lamp units designated by the control signal and determines whether the designated road lamp units are correctly extinguished. In the determination, the camera control section 32 can determine, for example, by using the threshold, whether the road lamp units are correctly extinguished. It is possible to detect a deficiency of the road lamp units according to this operation.

If the management apparatus 2 transmits a control signal for controlling dimming of a part or all of the monitoring target road lamp units, the camera control section 32 performs the operation determination in Act 4 concerning the road lamp units designated by the control signal and determines whether the designated road lamp units are correctly dimmed. In the determination, the camera control section 32 can determine, for example, by checking a change in the brightness of regions corresponding to the road lamp units, whether the road lamp units are correctly dimmed. It is possible to detect a deficiency of the road lamp units according to this operation.

In this embodiment, for convenience of explanation, the plurality of road lamp units are monitored. However, the number of road lamp units to be monitored may be one.

In this embodiment, the region information for specifying image positions of the light sources of the monitoring target road lamp units is stored in the storing section 33. However, the present embodiment is not limited to this. For example, image positions on the ground on which light is irradiated may be stored as the region information.

In this embodiment, the management apparatus 2 registers the posture control information of the camera unit, the identifiers for identifying the road lamp units, and the region information for specifying image positions of the light sources of the road lamp units in the storing section 33. However, for example, if monitoring target road lamp units are fixedly determined, there kinds of information may be registered in the storing section 33 in advance not by registration processing by the management apparatus 2.

### Second Embodiment

### Configuration Example of the Road Lamp System

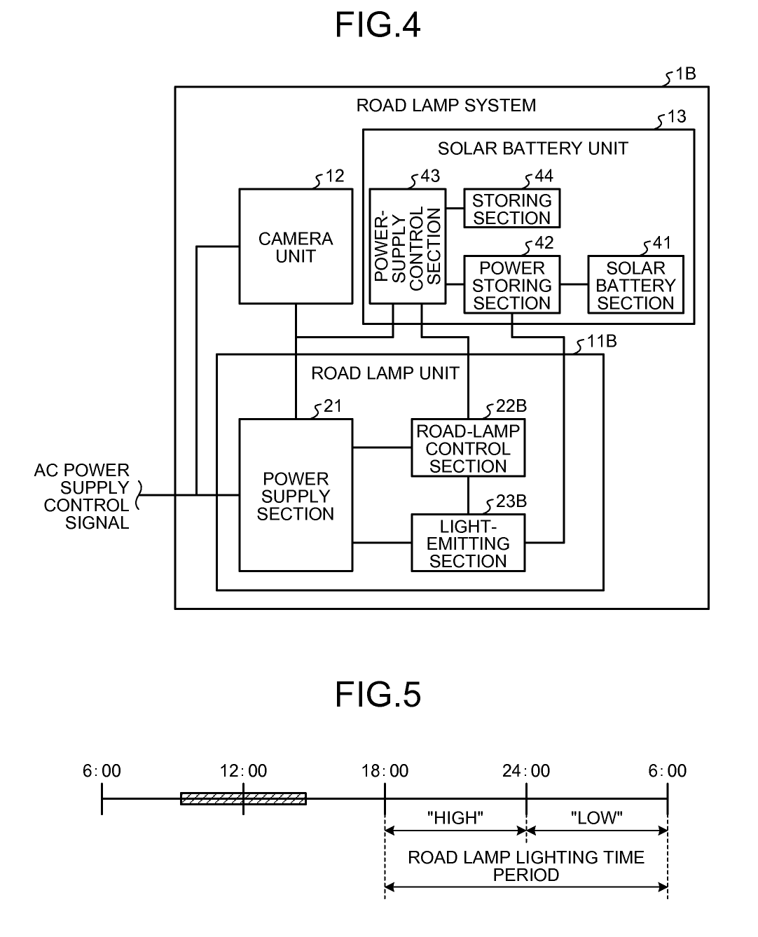

FIG. 4 is a diagram showing an example of the configuration of a road lamp system according to a second embodiment. Components same as the components of the road lamp system according to the first embodiment explained above are denoted by the same reference numerals and signs and explanation of the components is omitted. The configuration of a road lamp control system is the same as the configuration shown in FIG. 1 in the first embodiment.

In FIG. 4, as an example of the road lamp system 1 shown in FIG. 1, a road lamp system 1B including a road lamp unit 11B, the camera unit 12, and a solar battery unit 13 is shown. The road lamp unit 11B includes the power supply section 21, a road-lamp control section 22B, and a light-emitting section 23B. The solar battery unit 13 includes a solar battery section 41, a power storing section 42, a power-supply control section 43, and a storing section 44. In addition to the function of the road-lamp control section 22, the road-light control section 22B performs, on the basis of a control signal received from the power-supply control section 43, control for switching electric power supplied to the light-emitting section 23B. The light-emitting section 23B is driven by the power supply section 21 or the power storing section 42 to perform ON and OFF processing and dimming processing according to the control by the road-lamp control section 22B.

In FIG. 4, the solar battery section 41 has a power generating function for converting sunlight into energy. The power storing section 42 has a charging function for storing electric power generated by the solar battery section 41. The power-supply control section 43 determines whether the power supply section 21 is used or the power storing section 42 is used as a power supply for driving the light-emitting section 23B and notifies the road-lamp control section 22B of a control signal indicating a result of the determination. In the storing section 44, information concerning a road lamp lighting time period, information concerning electricity charges, and the like are stored.

### Operation of the Road Lamp System

A characteristic operation of the road lamp system 1B according to this embodiment is explained. In this embodiment, as an example, a period of time 18:00 to 6:00 next morning is set as a road lamp lighting time period, time 18:00 is set as ON time, and time 6:00 next morning is set as OFF time. It is assumed that information concerning the road lamp lighting time period is registered in the storing section 44 in advance by the management apparatus 2. As an example, this embodiment is premised that electricity charges are different between a period of time 18:00 to 24:00 and a period of time 24:00 to 6:00 and higher charges are set for the period of time 18:00 to 24:00 than for the period of time 24:00 to 6:00. It is assumed that information concerning the electricity charges is registered in the storing section 44 in advance by the management apparatus 2. These kinds of information (the road lamp lighting time period and the electricity charges) can be updated as appropriate by the operator (the user) of the management apparatus 2 according to a state of use of the system. FIG. 5 is a diagram showing an overview of the information concerning the road lamp lighting time period and the electricity charges in this embodiment.

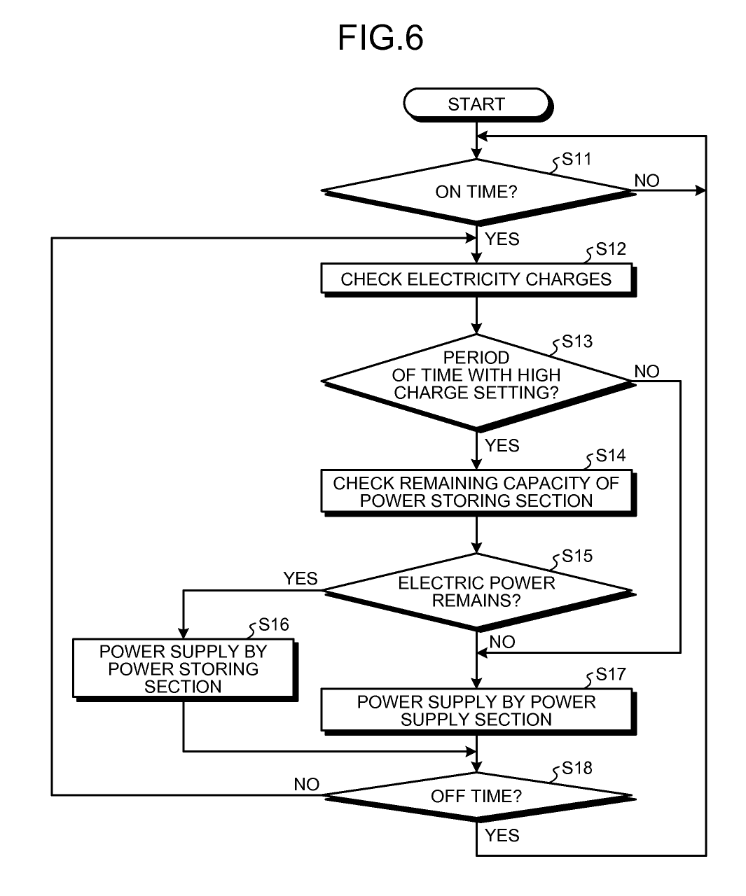

FIG. 6 is a flowchart for explaining the operation of the power-supply control section 43. This embodiment is premised that the solar battery section 41 performs solar power generation and electric power necessary for driving of the light-emitting section 23B is sufficiently charged in the power storing section 42.

The power-supply control section 43 performs processing for checking whether present time coincides with the ON time registered in the storing section 44 (Act 11) and waits for the present time and the ON time to coincide with each other (No in Act 11). For example, if the present time coincide with the ON time (Yes in Act 11), the power-supply control section 43 reads out information concerning electricity charges from the storing section 44 and checks whether the present time is in the period of time with high charge setting (18:00 to 24:00) or the period of time with low charge setting (24:00 to 6:00) (Act 12).

For example, if the present time is in the period of time with high charge setting (Yes in Act 13), the power-supply control section 43 checks a remaining capacity of the power storing section 42 (Act 14). If electric power necessary for driving of the light-emitting section 23B remains (Yes in Act 15), the power-supply control section 43 notifies the road-lamp control section 22B of a control signal indicating that the power storing section 42 is used as a power supply for driving the light-emitting section 23B (Act 16). The road-lamp control section 22B performs, on the basis of the control signal, control for using the power storing section 42 as the power supply for driving the light-emitting section 23B and lights the light-emitting section 23B.

On the other hand, if the electric power necessary for driving the light-emitting section 23B does not remain in the power storing section 42 in the check processing in Act 14 (No in Act 15), the power-supply control section 43 notifies the road-lamp control section 22B of a control signal indicating that the power supply section 21 is used as the power supply for driving the light-emitting section 23B (Act 17). The road-lamp control section 22B performs, on the basis of the control signal, control for using the power supply section 21 as the power supply for driving the light-emitting section 23B and lights the light-emitting section 23B.

If the present time is in the period of time with low charge setting in the check processing in Act 12 (No in Act 13), the power-supply control section 43 notifies the road-lamp control section 22B of a control signal indicating that the power supply section 21 is used as the power supply for driving the light-emitting section 23B (Act 17). The road-lamp control section 22B performs, on the basis of the control signal, control for using the power supply section 21 as the power supply for driving the light-emitting section 23B and lights the light-emitting section 23B.

After executing the processing in Act 16 or Act 17, the power-supply control section 43 performs processing for checking whether the present time coincides with the OFF time registered in the storing section 44 (Act 18). The power-supply control section 43 repeatedly executes the processing in Act 12 to Act 17 until the present time coincides with the OFF time (No in Act 18). If the present time coincides with the OFF time (Yes in Act 18), the power-supply control section 43 shifts to the processing for checking whether the present time coincides with the ON time (Act 11) and notifies the road-lamp control section 22B of a control signal indicating that the present time is the OFF time. The road-lamp control section 22B performs, on the basis of the control signal, control for extinguishing the light-emitting section 23B.

For example, in this embodiment, the ON time 18:00 is in the period of time with high charge setting and the electric power necessary for driving the light-emitting section 23B is charged in the power storing section 42 at the ON time (see the premise explained above). Therefore, the light-emitting section 23B irradiates light using the power storing section 42 as the driving power supply. Thereafter, at a point when the present time is 24:00, the period of time with high charge setting is switched to the period of time with low charge setting. Therefore, the power-supply control section 43 and the road-lamp control section 22B perform switching control for the power supply. Thereafter, the light-emitting section 23B maintains a lighting state using the power supply section 21 as the driving power supply.

If the electric power of the power storing section 42 runs short in the period of time 18:00 to 24:00, even if the period of time is the period of time with high charge setting, the switching control for the power supply is performed by the power-supply control section 43 and the road-lamp control section 22B. The light-emitting section 23B uses the power supply section 21 as the driving power supply.

If the present time is the OFF time 6:00, the power supply is disconnected according to the control by the power-supply control section 43 and the road-lamp control section 22B. The light-emitting section 23B is extinguished.

### Effects of the Second Embodiment

As explained above, in this embodiment, the solar battery unit 13 autonomously performs the control for selecting an optimum power supply. Consequently, it is possible to reduce electricity charges.

In this embodiment, it is also possible to use the electric power stored in the power storing section 42 for a purpose other than road lamp lighting at peak time of power consumption when the road lamp system is not used (see a hatched part in FIG. 5). For example, priority levels are respectively set for the road lamp lighting and purposes (one or plural) other than the road lamp lighting and stored in the storing section 44. If a priority level of a purpose other than the road lamp lighting is high, the operation shown in FIG. 6 is not executed. Alternatively, a method of specifying in advance a threshold of electric energy usable for lighting road lamps (e.g., electric energy of 50% of full charge) and always using the electric energy of 50% of the full charge for a purpose other than the road lamp lighting is also conceivable. In this method, if the electric energy stored in the power storing section 42 falls below 50% of the full charge during lighting of the road lamps, the power-supply control section 43 forcibly performs control for switching the driving power supply from the power storing section 42 to the power supply section 21. By executing these kinds of processing, it is possible to effectively use electric power generated by the solar battery unit.

In this embodiment, as an example, the control for lighting the road lamps is started if the present time coincides with the ON time (Act 11). However, the present embodiment is not limited to this. The control for lighting the road lamps may be started, for example, if it is determined on the basis of an output value of a brightness sensor that the road lamps are shifted to the ON state (Act 11) or if a control signal for changing the road lamps to the ON state is received (Act 11).

### Third Embodiment

### Configuration Example of a Road Lamp System

In the second embodiment, the control for selecting an optimum power supply according to electricity charges is performed. In a third embodiment, control for adjusting the intensity of light according to electricity charges is performed. The configurations of a road lamp control system and a road lamp system are the same as the configurations in the first or second embodiment. In addition to the function explained in the first embodiment, the camera control section 32 in this embodiment further performs control for adjusting the intensity of light according to electricity charges. In the following explanation, as an example, the control for adjusting the intensity of light according to electricity charges is applied to the configuration in the first embodiment (FIG. 2).

### Operation of the Road Lamp System

A characteristic operation of the road lamp system 1A according to this embodiment is explained. In this embodiment, as in the second embodiment, it is assumed that information concerning a road lamp lighting time period and information concerning electricity charges are specified (see FIG. 5) and these kinds of information are registered in the storing section 33 in advance by the management apparatus 2.

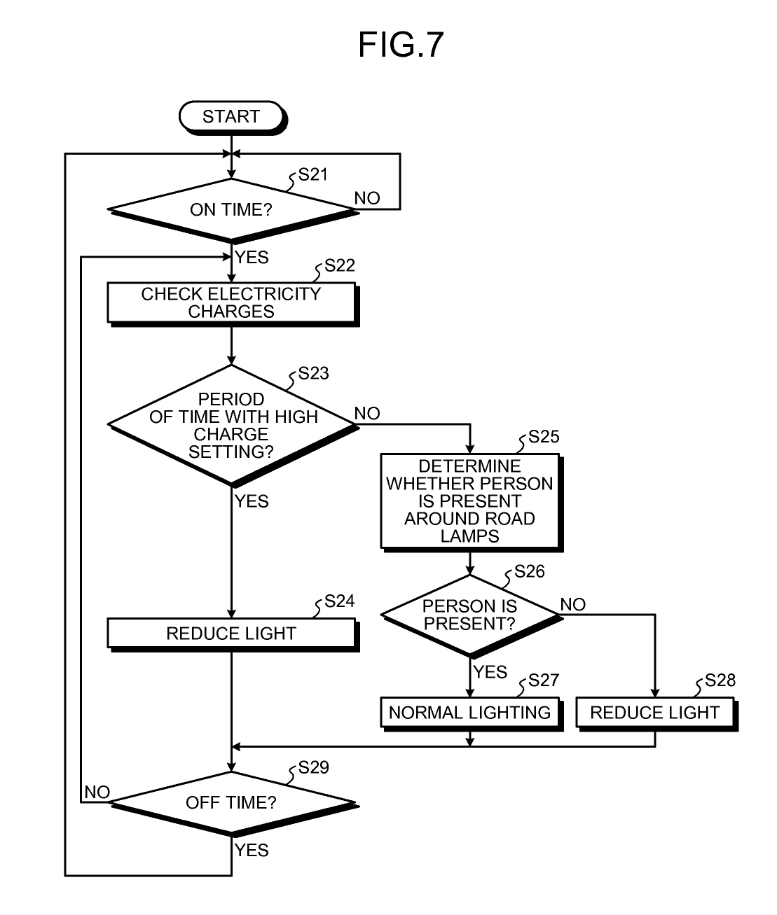

FIG. 7 is a flowchart for explaining the operation of the camera control section 32. In this embodiment, it is assumed that the image pickup section 31 sets the vicinity as an image pickup target according to the control by the camera control section 32 and transmits obtained image information to the camera control section 32.

The camera control section 32 performs processing for checking whether the present time coincides with the ON time registered in the storing section 33 (Act 21) and waits for the present time and the ON time to coincide with each other (No in Act 21). For example, if the present time coincide with the ON time (Yes in Act 21), the camera control section 32 reads out information concerning electricity charges from the storing section 33 and checks whether the present time is in the period of time with high charge setting (18:00 to 24:00) or in the period of time with low charge setting (24:00 to 6:00) (Act 22).

For example, if the present time is in the period of time with high charge setting (Yes in Act 23), the camera control section 32 notifies, via the power supply section 21, the road-lamp control section 22 of a control signal indicating that the road lights are lit with the intensity of light weakened (with reduced light) (Act 24). The road-lamp control section 22 performs, on the basis of the control signal, control for adjusting the intensity of light and reduces light irradiated by the light-emitting section 23.

On the other hand, if the present time is in the period of time with low charge setting in the check processing in Act 22 (No in Act 23), the camera control section 32 determines whether a person is present around the road lamps on the basis of image information obtained from the image pickup section (Act 25). For example, the camera control section 32 determines whether a person is present around the road lamps on the basis of a change in time series of pixels in the image information obtained from the image pickup section 31. For example, if determining that a person is present (Yes in Act 26), the camera control section 32 notifies, via the power supply section 21, the road-lamp control section 22 of a control signal indicating that the road lamps are lit at normal brightness (Act 27). The road-lamp control section 22 lights the light-emitting section 23 at the normal brightness on the basis of the control signal. If determining that a person is absent in the determination processing in Act 25 (No in Act 26), the camera control section 32 notifies, via the power supply section 21, the road-lamp control section 22 of a control signal indicating that the road lamps are lit with reduced light (Act 28). The road-lamp control section 22 performs, on the basis of the control signal, control for adjusting the intensity of light and reduces the light irradiated by the light-emitting section 23.

After executing the processing in Act 24, Act 27, or Act 28, the camera control section 32 performs processing for checking whether the present time coincides with the OFF time registered in the storing section 33 (Act 29). The camera control section 32 repeatedly executes the processing in Act 22 to Act 28 until the present time coincides with the OFF time (No in Act 29). If the present time coincides with the OFF time (Yes in Act 29), the camera control section 32 shifts to the processing for checking whether the present time coincides with the ON time (Act 21) and notifies the road-lamp control section 22 of a control signal indicating that the present time is the OFF time. The road-lamp control section 22 performs, on the basis of the control signal, control for extinguishing the light-emitting section 23.

For example, in this embodiment, since the ON time 18:00 is in the period of time with high charge setting, the light-emitting section 23 reduces and irradiates light. Thereafter, at a point when the present time is 24:00, the period of time with high charge setting is switched to the period of time with low charge setting. Therefore, the camera control section 32 and the road-lamp control section 22 perform control for adjusting light intensity if a person is present around the road lamps. The light-emitting section 23 irradiates light at normal intensity without reducing the light. Even if the present time is 24:00 and the period of time with high charge setting is switched to the period of time with low charge setting, if a person is absent around the road lamps, the camera control section 32 and the road-lamp control section 22 do not perform the control for adjusting the intensity of light. The light-emitting section 23 maintains a state of reduced light and irradiates the light.

If the present time is the OFF time 6:00, the power supply is disconnected according to the control by the camera control section 32 and the road-lamp control section 22. The light-emitting section 23 is extinguished.

### Effects of the Third Embodiment

As explained above, in this embodiment, the camera unit 12 autonomously controls the intensity of light according to electricity charges and a state around the road lamps. Consequently, it is possible to perform optimum dimming control.

In this embodiment, as an example, the control for lighting the road lamps is started if the present time coincides with the ON time (Act 21). However, the present embodiment is not limited to this. The control for lighting the road lamps may be started, for example, if it is determined on the basis of an output value of a brightness sensor that the road lamps are shifted to the ON state (Act 21) or if a control signal for changing the road lamps to the ON state is received (Act 21).

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A road lamp system including a light-emitting section configured to irradiate light and a monitoring camera section, the road lamp system comprising:
a power supply section configured to operate as a driving power supply for the light-emitting section and perform power line communication with an external apparatus;
a road-lamp control section configured to receive a control signal from the external apparatus via the power supply section and control the light-emitting section on the basis of the control signal; and
a camera control section configured to receive the control signal and determine, on the basis of image information transmitted from the monitoring camera section, whether a control operation instructed by the control signal is executed.

2. The system according to claim 1, wherein the camera control section determines, concerning the respective light-emitting sections of a plurality of road lamps including the own system, whether the control operation instructed by the control signal is executed.

3. The system according to claim 1, wherein
the control signal is a control signal for controlling ON or OFF of the light-emitting section, and
the camera control section determines whether the light-emitting section is turned on or off.

4. The system according to claim 1, wherein, if the camera control section determines that the control operation instructed by the control signal is not executed, the camera control section transmits a notification signal including a result of the determination to the external apparatus.

5. The system according to claim 1, further comprising:
a power storing section configured to store electric power obtained by solar power generation; and
a power-supply control section configured to determine whether the driving power supply for the light-emitting section is the power supply section or the power storing section, wherein
the road-lamp control section performs, according to a result of the determination by the power-supply control section, control for switching the driving power supply for the light-emitting section.

6. The system according to claim 5, wherein the power-supply control section determines, on the basis of information concerning a road lamp lighting time period and information concerning electricity charges set for each of time periods, whether the driving power supply is the power supply section or the power storing section.

7. The system according to claim 5, wherein the electric power stored in the power storing section can be used for purposes other than road lamp lighting.

8. The system according to claim 1, wherein the camera control section controls, on the basis of information concerning a road lamp lighting time period, information concerning electricity charges set for each of time periods, and image information, intensity of the light irradiated by the light-emitting section.
